(19) United States
(12) Patent Application Publication
(10) Pub. No.: US 2024/0220521 A1
(43) Pub. Date: Jul. 4, 2024

(54) METHOD AND SYSTEM FOR GENERATING A TEXTUAL RESPONSE USING A TEXTUAL QUARRY

(71) Applicant: Gal EHRLICH, Tel-Aviv (IL)

(72) Inventor: Gal EHRLICH, Tel-Aviv (IL)

(21) Appl. No.: 18/092,143

(22) Filed: Dec. 30, 2022

(51) Int. Cl. G06F 16/33; G06F 16/332; G06F 16/338; G06F 40/40

(52) U.S. Cl. CPC G06F 16/3344; G06F 16/3322; G06F 16/338; G06F 40/40

(57) ABSTRACT

Method and system for generating a textual response to a textual quarry, such as a natural language query. The method comprises the steps of: (a) receiving a textual quarry; (b) querying a database using the textual quarry to retrieve relevant data; (c) processing the retrieved data to generate a textual response; (d) updating the textual quarry as desired; (e) repeating steps (b) through (d) as necessary to generate an updated textual response based on the updated textual quarry; and (f) highlighting any changes made to the response and optionally the quarry. The system comprises components for implementing the method.

### FIELD OF THE INVENTION

The present invention relates to the field of natural language processing and, more specifically, to a method and system for generating a textual response to a textual quarry.

### BACKGROUND OF THE INVENTION

Natural language processing (NLP) is a field of artificial intelligence that deals with the interaction between computers and humans through the use of natural language. It enables computers to understand, interpret, and generate human language.

One common application of NLP is generating responses to queries or questions posed in natural language. This is often done using a database of pre-defined queries and corresponding responses. However, these pre-defined responses may not always be accurate or sufficient for a given query, and there is a need for a method and system that can adapt and generate more accurate responses based on previous queries and responses.

### SUMMARY OF THE INVENTION

The present invention provides a method and system for generating a textual response to a textual quarry, such as a natural language query. The method comprises the steps of: (a) receiving a textual quarry; (b) querying a database using the textual quarry to retrieve relevant data; (c) processing the retrieved data to generate a textual response; (d) updating the textual quarry as desired; (e) repeating steps (b) through (d) as necessary to generate an updated textual response based on the updated textual quarry; and (f) highlighting any changes made to the response and optionally the quarry.

The system of the present invention comprises: (a) a processor; (b) a memory storing a set of instructions executable by the processor, the instructions comprising: (i) a module for receiving a textual quarry; (ii) a module for querying a database using the textual quarry to retrieve relevant data; (iii) a module for processing the retrieved data to generate a textual response; (iv) a module for updating the textual quarry as desired; (v) a module for repeating steps (ii) through (iv) as necessary to generate an updated textual response based on the updated textual quarry; and (vi) a module for highlighting any changes made to the response and optionally the quarry.

In one embodiment, the system further comprises a user interface for inputting the textual quarry and displaying the generated response. In another embodiment, the database comprises a set of pre-defined queries and corresponding responses. In yet another embodiment, the system further comprises a machine learning module for adapting the system to generate more accurate responses based on previous queries and responses.

In one embodiment, the method further comprises storing the updated textual response in a database for future reference. In another embodiment, the method further comprises displaying the updated textual response to a user through a user interface. In yet another embodiment, the method further comprises adapting the system to generate more accurate responses based on previous queries and responses using machine learning.

In one embodiment, the textual quarry is a natural language query. In another embodiment, the method further comprises providing suggestions for updating the textual quarry based on previous queries and responses. In yet another embodiment, the system further comprises a module for providing suggestions for updating the textual quarry based on previous queries and responses.

In one embodiment, the method further comprises displaying the updated textual response in a visually distinct manner from the original response to indicate the changes made. In another embodiment, the system further comprises a module for displaying the updated textual response in a visually distinct manner from the original response to indicate the changes made.

In one embodiment, the method further comprises automatically updating the response when the quarry is updated, without requiring explicit input from a user. In another embodiment, the system further comprises a module.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart illustrating the steps of the method of the present invention for generating a textual response using a textual quarry.

FIG. 2 is a block diagram illustrating the components of the system of the present invention for generating a textual response using a textual quarry.

### DESCRIPTION OF SPECIFIC EMBODIMENTS OF THE INVENTION

The present invention provides a method and system for generating a textual response to a textual quarry, such as a natural language query. The method comprises the steps of: (a) receiving a textual quarry; (b) querying a database using the textual quarry to retrieve relevant data; (c) processing the retrieved data to generate a textual response; (d) updating the textual quarry as desired; (e) repeating steps (b) through (d) as necessary to generate an updated textual response based on the updated textual quarry; and (f) highlighting any changes made to the response and optionally the quarry.

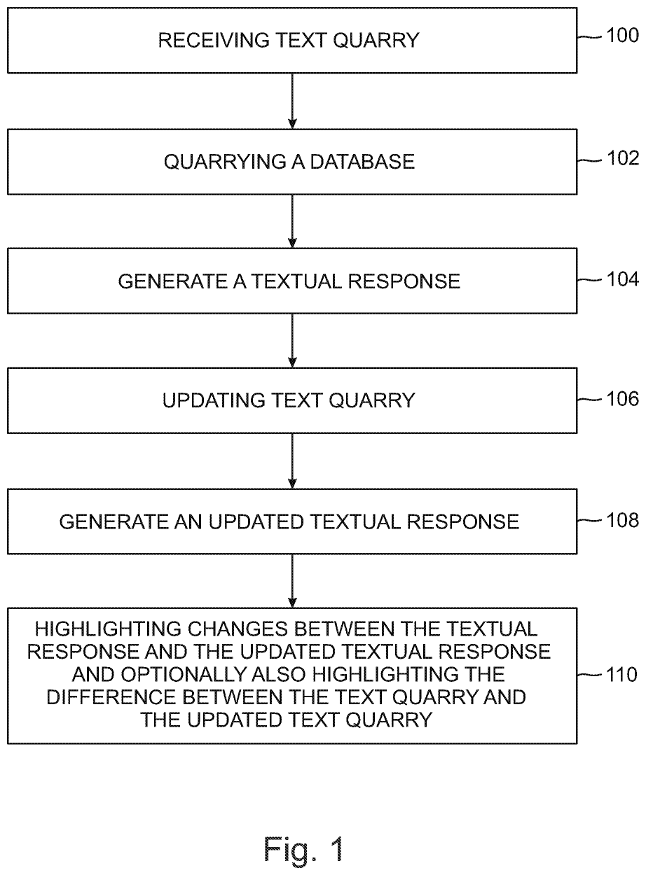

The method is illustrated in the flowchart of FIG. 1. In step 100, the method begins by receiving a textual quarry. The textual quarry may be inputted by a user through a user interface, or it may be received from another system or device. In step 102, the method queries a database using the textual quarry to retrieve relevant data. The database may be a local database or a remote database accessed over a network. In step 104, the method processes the retrieved data to generate a textual response. This may involve formatting the data, selecting relevant information, and generating a response in natural language.

In step 106, the method updates the textual quarry as desired. This may involve modifying the wording or structure of the quarry, or adding or removing information. In step 108, the method repeats steps 102 through 104 as necessary to generate an updated textual response based on the updated textual quarry. This may involve re-querying the database and re-processing the retrieved data to generate a new response. In step 110, the method highlights any changes made to the response and optionally the quarry. This may involve displaying the updated response in a visually distinct manner, such as using a different color or font, to indicate the changes made. All “track changes” as such appear in the software MICROSOFT WORD are applicable herein to highlight changes.

The system of the present invention comprises: (a) a processor; (b) a memory storing a set of instructions executable by the processor, the instructions comprising: (i) a module for receiving a textual quarry; (ii) a module for querying a database using the textual quarry to retrieve relevant data; (iii) a module for processing the retrieved data to generate a textual response; (iv) a module for updating the textual quarry as desired; (v) a module for repeating steps (ii) through (iv) as necessary to generate an updated textual response based on the updated textual quarry; and (vi) a module for highlighting any changes made to the response and optionally the quarry.

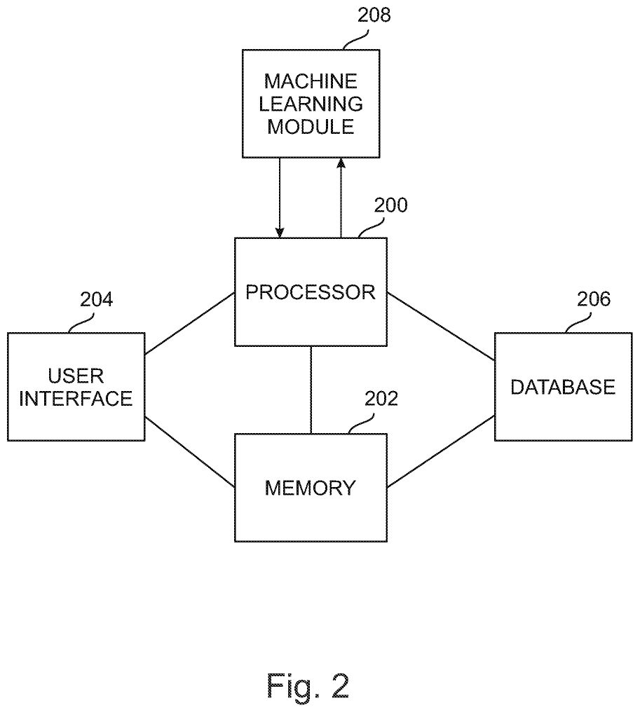

The system is illustrated in the block diagram of FIG. 2. The processor 200 is connected to the memory 202, which stores the instructions for the system. The system also includes a user interface 204 for inputting the textual quarry and displaying the generated response. The system is connected to a database 206, which may be a local database or a remote database accessed over a network. The system may also include a machine learning module 208 for adapting the system to generate more accurate responses based on previous queries and responses.

In one embodiment, the database 206 comprises a set of pre-defined queries and corresponding responses. The system may use these pre-defined responses as a starting point and modify them as necessary to generate an updated response based on the updated quarry.

In another embodiment, the system further comprises a module for providing suggestions for updating the textual quarry based on previous queries and responses. This module may use machine learning techniques to analyze past queries and responses and identify patterns or common themes that can be used to suggest updates to the current quarry. For example, if a user frequently asks about the weather in a particular location, the system may suggest adding the location to the quarry to generate a more accurate response.

In yet another embodiment, the system is configured to automatically update the response when the quarry is updated, without requiring explicit input from a user. This may be useful in situations where the quarry is being constantly updated, such as in a chatbot or virtual assistant application.

The system and method of the present invention have several advantages over prior art systems and methods. First, the ability to update the quarry allows for more flexible and accurate responses to be generated. By allowing the user to modify the quarry, the system can generate a more tailored response that is specific to the user's needs. Additionally, the use of machine learning techniques allows the system to adapt and improve over time, resulting in more accurate responses to future queries.

Furthermore, the ability to highlight changes made to the response allows the user to easily see the updates made to the response and understand how the updated quarry has affected the response. This can be especially useful in situations where multiple users are collaborating on a project and need to track changes to the response.

In conclusion, the present invention provides a method and system for generating a textual response to a textual quarry that is flexible, accurate, and adaptable. It is expected that the present invention will find wide applications in the field of natural language processing and provide significant benefits to users.

The use of the terms “a” and “an” and “the” and similar referents in the context of describing the invention (especially in the context of the following claims) are to be construed to cover both the singular and the plural, unless otherwise indicated herein or clearly contradicted by context. The use of the term “at least one” before a list of one or more items (for example, “at least one of A and B”) means that the list is not exclusive and that any combination of two or more of the listed items may be used.

The word “exemplary” is used herein to mean “serving as an example, instance, or illustration.” Any embodiment described as “exemplary” is not necessarily to be construed as preferred or advantageous over other embodiments.

The present invention has been described with reference to particular embodiments and examples, but it will be understood by those skilled in the art that the invention is not limited to the embodiments or examples described. The scope of the invention is defined by the appended claims and their equivalents, rather than by the foregoing description.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. § 1.72(b) to allow the reader to quickly ascertain the nature of the technical disclosure. It is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

It will be understood that the present invention may be embodied in other specific forms without departing from the spirit or essential characteristics thereof. The presently disclosed embodiments are therefore considered in all respects to be illustrative and not restrictive. The scope of the invention is indicated by the appended claims rather than the foregoing description, and all changes that come within the meaning and range of equivalence thereof are intended to be embraced therein.

It will be understood that although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

The terms “comprises”, “comprising”, “includes”, “including”, “having” and their conjugates mean “including but not limited to”.

The term “consisting of” means “including and limited to”.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

It should be noted that the figures are only intended to facilitate the description of the preferred embodiments of the present invention. The figures do not describe every aspect of the present invention and do not limit the scope of the invention.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

The present invention has been described with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

It is intended that the following claims be interpreted to embrace all the features of the invention disclosed herein, and all statements that are within the scope of the claims, and be given their broadest interpretation in view of the prior art. It is intended that the following claims be interpreted to embrace all the features of the invention disclosed herein, and all statements that are within the scope of the claims, and be given their broadest interpretation in view of the prior art.

1. A method for improving an accuracy of a computerized system in generating a textual response using a textual quarry, the method comprising:
by a processor of said computerized system:
(a) receiving a textual quarry;
(b) querying a database using the textual quarry to retrieve relevant data;
(c) processing the retrieved data;
improving an accuracy of the computerized system in generating textual response by:
(d) using machine learning module, which is based on previous queries and responses, to generate a textual response to said quarry based on said processing:
(e) updating the textual quarry as desired, and
(f) automatically repeating steps (b) through (d) to generate an updated textual response based on the updated textual quarry, without requiring explicit input from a user;
(g) highlighting any changes between said generated textual response and said generated updated textual response, and optionally highlighting any changes between said received textual quarry and said updated textual quarry; and
(h) providing suggestions for updating the textual quarry based on previous queries and responses by using said machine learning module to analyze past queries and responses and identify patterns or common themes that can be used to suggest updates to the textual quarry.

2. A system with improved accuracy in generating a textual response using a textual quarry, the system comprising:
(a) a processor;
(b) a memory storing a set of instructions executable by the processor, the instructions comprising:
(i) a module for receiving a textual quarry;
(ii) a module for querying a database using the textual quarry to retrieve relevant data;
(iii) a module for processing the retrieved data;
(iv) a machine learning module that improves an accuracy of the system in generating textual response, the machine learning module uses previous queries and responses, for generating a textual response to said quarry based on said processing;
(v) a module for updating the textual quarry as desired;
(vi) a module for automatically repeating steps (ii) through (v) to generate an updated textual response based on the updated textual quarry, without requiring explicit input from a user;
(vii) a module for highlighting any changes between said generated textual response and said generated updated textual response, and optionally highlighting any changes between said received textual quarry and said updated textual quarry; and
(viii) a module for providing suggestions for updating the textual quarry based on previous queries and responses by using said machine learning module to analyze past queries and responses and identify patterns or common themes that can be used to suggest updates to the textual quarry.

3. The system of claim 2, further comprising a user interface for inputting the textual quarry and displaying the generated response.

4. The system of claim 2, wherein the database comprises a set of pre-defined queries and corresponding responses.

5. (canceled)

6. The method of claim 1, further comprising storing the updated textual response in a database for future reference.

7. The method of claim 1, further comprising displaying the updated textual response to a user through a user interface.

8. (canceled)

9. The method of claim 1, wherein the textual quarry is a natural language query.

10-11. (canceled)

12. The method of claim 1, further comprising displaying the updated textual response in a visually distinct manner from the textual response to indicate the changes made.

13. The system of claim 2, further comprising a module for displaying the updated textual response in a visually distinct manner from the textual response to indicate the changes made.

14-15. (canceled)
